(19) United States
(12) Patent Application Publication
(10) Pub. No.: US 2016/0309752 A1
(43) Pub. Date: Oct. 27, 2016

(54) NON-SWEET BINDER FOR FOOD PRODUCTS

(71) Applicant: Olusola Lamikanra, Frisco, TX (US)

(72) Inventor: Olusola Lamikanra, Frisco, TX (US)

(21) Appl. No.: 14/695,222

(22) Filed: Apr. 24, 2015

(51) Int. Cl. A23L 1/29; A23L 1/36; A23L 1/164

(52) U.S. Cl. CPC A23L 1/296; A23L 1/1643; A23L 1/362; A23V 2002/00

(57) ABSTRACT

A non-sweet binder for a meal replacement food product, the binder composition comprising at least one starch component, dispersed in an aqueous medium forming an aqueous binder solution. The aqueous binder solution is heat treatable to achieve a desired viscosity that allows cohesion of a plurality of ingredients and shaping of the food product without substantial modification in nutritional value of final food product.

This application claims priority to U.S. provisional application Ser. No. 62/025,388 filed Jul. 16, 2014, and entitled “Non-Sweet Binder And Food Product”, owned by the assignee of the present application and herein incorporated by reference in its entirety.

### FIELD OF THE INVENTION

The present invention generally relates to binders for food products and more specifically relates to a non-sweet binder composition for use in meal replacement products including nutritive edible bars that provide meal-like eating experience.

### BACKGROUND OF THE INVENTION

Consumers are not only concerned about nutritional and potential health benefits of food products, but also their organoleptic attributes, which are highly valued and often act as major drivers of sale and consumption of food products. Nutrition bars including protein bar, meal bar, energy bar, weight loss bar, bite size nutritional food products, and the like, constitute a substantial portion of meal replacement products and healthy snacks.

A variety of components including combinations of sugars and carbohydrates, proteins, fats and oils have traditionally been used as binders to form compact, ready-to-eat food products including nutrition bars. The binding process customarily used to hold individual components together in nutritive bars and meal replacement products usually require high quantities of sugars and/or syrups as binding agents.

Attempts to develop non-sweet and/or savory food products using conventional binder constituents with minimal amounts of sugar, syrups and/or sugar alcohols for binding requirements have been unsuccessful because certain level of sweetness is still retained in the final food product. As a result, consumers of edible nutritive bars or meal supplement bars have had to accept high levels of sugar/syrup content and sweet taste as traits associated with edible bars, in spite of their desire to limit sugar intake.

There is a long felt need to provide non-sweet binders which can be used in meal replacement products, particularly nutritive bars including savory edible bars which are largely limited to very few niche offerings. To overcome the need to add sugary binders, these food products have essentially relied on using increased amounts of fatty ingredients that are solid at room temperature, for example: peanut or almond butter and/or milled grains and its flour are used to form dough that are blended with other ingredients of the nutrition bar. The blended products are then baked, typically with addition of baking powder. Consequently, these meal replacement products are usually high in fat and/or carbohydrate content and the final product may possess the consistency of baked and dried dough product embedded with grounded ingredients.

The sweet flavor resulting from the use of existing syrup and sugar based binders, and high calorie value resulting from the added fat or oil based binders, along with the lack of satisfactory non-sweet binder technology have severely limited meal replacement product offerings in the marketplace. Savory meal replacement bars and similar nutritional food products with flavors that provide a real meal experience is an unmet consumer need. For example, unlike salty snacks, nuts and cheese that are often paired with and used to complement savory meals and beverages such as wine and beer, the sweetness of existing nutritive bars limit their use occasions and ability to be consumed as accompanying food items with meals and beverages. They are often consumed alone, consumed along with neutral flavored or sweet drinks and/or stimulating drinks such as coffee, or as dessert-like after meal product. Additionally, underserved cohorts such as vegans, ovo-vegetarians and lacto-vegetarians currently have very limited options, due to the dominating presence of dairy and egg based products in meal replacement product market.

In light of the foregoing description, the following prior art patents are cited as pertinent to provide insights into previous work on the development of binding systems used for developing non-sweet and savory shelf stable meal replacement food products.

U.S. Pat. No. 4,910,031 discloses a process to improve savory snack foods including a non-sweet, sugar-based binder, which adheres one or more toppings to a base portion of the snack. The art describes a binder product that may be sprayed on the surface of the snack chips in order to assist in the adhesion of other seasonings or flavorings to the surface of the chip. Sugars used were selected from the group consisting of maltodextrin, fructose, glucose, high fructose syrup and corn syrup solids.

U.S. Ser. No. 19/940,04022 discloses savory food binder matrices comprising a combination of a functional protein, a cereal, and a hydrocolloid. The formed food products of this invention are usually stored in the refrigerated or frozen state and are cooked normally with either the use of a microwave oven, conventional oven, grill, or deep frying to prepare the food products for consumption.

US20030087004 discloses a process for making sweet and non-sweet food bars for meal-equivalent nutrition segments by limiting the amounts of carbohydrates and sugars to less than 10% wt (% of total bar weight). Product formulation includes added vegetable oils and protein isolate.

EP2201846 discloses the use of aqueous-based non-sweet binder compositions comprising of soluble fiber, protein and fat for food products, and methods of preparing such aqueous-based non-sweet binder compositions.

US20060088628 discloses the process for formulating a binding system for savory bars that includes a binder comprising at least 40 wt. % or higher of solids, based on total solids in the binder, of one or more fibrous ingredient and at least 1 wt. % of a compound which includes glycerol and/or fatty acid moieties.

US20070065557 discloses applications to a savory food binder composition of about 10-25% moisture content comprising of a fat, a hydrocolloid, a non-hydrocolloid carbohydrate, including glycerin and an emulsifier. The binder can be used in the preparation of savory snack bars, savory nutritional bars or in savory products used as snack or meal replacement food products.

US20100136195 teaches an art related to non-sweet binder compositions, food products comprising such binder compositions, and methods of preparing food products comprising such binder compositions. The food products are formulated using aqueous based non-sweet binder compositions, the binder composition comprising soluble fiber, protein, fat, and less than 5 weight percent of added high calorie sweetener.

U.S. Pat. No. 7,914,833 discloses the art of providing baking stability by incorporating high amylopectin starch cross-linked as di-starch-phosphate or di-starch-adipate and/or stabilized as starch acetate from roots and tubers in creams, fillings, toppings, glazes and other bakery products. The starches provide gel-strength, viscosity, glaze, texture or creaminess to the cream or filling.

WO2013141854 discloses a coating for food and a food product wherein the binding agent can include corn syrup, soluble corn fiber, glucose syrup and/or high-fructose corn syrup. Added corn syrup to the binder may soften the texture, add volume, prevent crystallization of sugar, enhance flavor, and/or minimize the sweetness impact of the binding agent. The binder formulation can also include about 20 to 30% maltodextrin by weight about 12 to 15% starch, with the latter added to the binder as a thickening agent.

US 20090148563 discloses a savory food binder composition comprising: between about 25 to about 50% by weight of moisture content, between about 15 to about 25% by weight of a fat, between about 20 to about 30% by weight of a food hydrocolloid, and between about 10 to about 30% by weight of a non-hydrocolloid carbohydrate. The savory food binder composition can be used in the preparation and manufacture of savory crunchy granola-type bars.

US 20060134312 discloses wetting agent comprising at least 40 wt. % or higher of solids of one or more fibrous ingredient and at least 1 wt. % of a compound which includes glycerol and/or fatty acid. The wetting agent was claimed to be useful as a binding system for savory food bars.

US 20070087084 discloses a process to produce low-calorie multi-textured nutrition energy food bars with high soluble fiber and reduced sugar alcohol contents with a binder system that may comprise carbohydrate based syrup, such as a sugar syrup

US20140093635 discloses snack food product comprising of oil and seasoning coated granola clusters and solubilized corn fiber binder. The coated granola and binder can be used in the production of savory granola food products designed to provide a satisfying snack between meals or in place of a meal.

Thus, there still remains a need for non-sweet food binder options that can be used for the development of non-sweet, low calorie, meal-like snacks and meal replacement products.

### SUMMARY OF THE INVENTION

The present invention relates to food binder compositions that can be advantageously used in the development of non-sweet and savory food products including meal replacement food products such as nutrition bars or energy bars.

In an embodiment, the present invention relates to a non-sweet binder for a food product, the binder composition comprising: at least one starch component, about 1 to 20 percent by weight, dispersed in an aqueous medium forming an aqueous binder solution, wherein the aqueous binder solution is heat treatable to achieve a desired viscosity that allows cohesion of a plurality of ingredients and shaping of the food product without substantial modification in nutritional value.

In another embodiment, the present invention relates to a meal replacement food product comprising the aqueous based non-sweet binder and a plurality of dried food components selected from a group consisting of nuts, seeds, grains and seasoning. The food product is substantially free of gluten, added sugar, hydrolyzed polysaccharides, sugar alcohols, colloidal substances and fats but offers a good source of protein, fiber and essential oils and less calorific value contributed by the non-sweet binder.

### BRIEF DESCRIPTION OF DRAWINGS

FIG. 1 shows a savory edible bar containing almond, flax seed, sunflower seed and whole oat as the main ingredients.

FIG. 2 shows a savory edible bar containing cashew nut, sunflower seed and flax sees as the main ingredients.

FIG. 3 shows a savory edible bar containing pumpkin seed and chia seed as the main ingredients.

FIG. 4 shows a savory edible bar containing walnut, flax seed and chia seed as the main ingredients.

FIG. 5 shows a savory edible bite size food product containing peanut, sunflower seed and flax seed as the main ingredients.

FIG. 6 shows a savory edible bar containing popped quinoa and tapioca starch as the main ingredients.

FIG. 7 shows a savory edible bite size food product containing toasted oat and tapioca starch as the main ingredients.

### DESCRIPTION OF PREFERRED EMBODIMENTS

The term “binder” as used herein refers to a material or substance that is incorporated into a food product for the purpose of holding or drawing other material together to form a cohesive whole product from loosely assembled ingredients. Because the binder described herein is intended to be used in the production of food, it is preferably a food-grade binder. “Savory” is intended to mean non-sweet flavors that are aromatic, salty, cheesy and/or spicy. “Meal replacement product” as used herein refers to nutrition bars, nutritive bars, energy bars, granola bars, meal bars, protein bars and similar products that are bite size, square, spherical and/or irregular shaped.

According to an embodiment, the present invention relates to a non-sweet binder composition comprising of a starch component, physically modified or in its native form, dispersed in an aqueous medium resulting in a binder solution. The aqueous based binder composition, constitutes the sole and/or main added binder for bonding together a plurality of ingredients such as nuts, seeds, grains, and seasoning for preparation of meal replacement products. The non-sweet binder composition thereby eliminates the need to add other conventional binding materials such as high calorie sugars and syrups, sugar alcohols, gums, hydrolyzed polysaccharides, solubilized fibers, fats and/or oil, etc. In addition, the non-sweet binder does not require the food product ingredients to be ground, pulverized or finely chopped before mixing.

The simplicity provided through the non-sweet binder composition and its preparation has not been previously leveraged for its binding capability as a sole functional added binder for bonding ingredients in aggregated food products such as edible bars and meal replacement products. Since the binder by itself is bland and/or non-sweet with minimal impact on the flavor of the final product, it can be advantageously used in the development of diverse flavored food products such as savory flavored snacks and/or low calorie snacks.

The non-sweet binder composition of this invention preferably comprises a starch content of about 1 to about 20%, more preferably about 2% to about 7% by weight of the aqueous binder solution. The starch component can be from a single source or multiple sources mixed together as components of the binder. While the starch may be selected from a variety of plant sources including tubers, roots, rhizomes, corms, stems, seeds, grains and legumes, the preferred starch source is tapioca root. For example, the starch component is obtained from corn, lotus root, taro root, rice, tapioca, arrowroot, potato, kudzu, etc. Aqueous component of the binder comprises water or any food grade aqueous solution including fruit and vegetable juices/purees, fermentation products, broth, stock solutions, etc. The binder composition may include optional ingredients such as, flavorings, oils, sweeteners, emulsifiers, micronutrients, vitamins, minerals, coloring, and health and wellness enablers such as bio actives, essential fatty acids, and antioxidants. The binder compositions described herein allow the cohesion of the plurality of ingredients and also facilitate the shaping of the final food product such as a nutritive bar, without increasing its calorie content. Prepared food products incorporated with the above binder composition, will not disintegrate over time nor would they lose their structural form upon freezing, refrigeration or thawing.

According to one embodiment, the starch is dispersed in its pre-gelatinized form at an ambient or near ambient temperature to produce a binder composition with desired viscosity. The said binder, when used in the preparation of snack bars typically would contribute from less than 2 to about 15 calories per 40 g serving of the food product unlike most sugar-based binders which forms 25-50% of the food product and contribute about 60 to 90 calories per 40 gram serving of the food product.

In another embodiment, the aqueous binder composition is heated, microwaved or treated in a manner that results in starch gelatinization and/or modification until a desired viscosity is reached that can cause aggregation of food ingredients or edible components forming a food product.

According to another embodiment, an aqueous mixture, equivalent to the aqueous component of the binder composition, is added to an admixture of starch powder and dry food ingredients. The amount of ingredients could be in ratios that allow the resulting blended material to achieve a desired viscosity for aggregation at ambient temperature such that it permits shaping of the food product. The binder composition can also be subjected to treatment at controlled temperatures to modify viscosity to an appropriate level. In an embodiment, the non-sweet binder composition, comprises between about 85% to about 99% by weight of moisture content.

According to an embodiment, the binder preferably comprises a combination of pre-gelatinized and native starch. The pre-gelatinized starch causes an increase in viscosity of the binder at ambient temperature and thus facilitates aggregation of the food components without the need to heat the binder mixture. Presence of the native starch permits addition of the right amount of pre-gelled starch needed to hold dry ingredient components together at ambient temperature. The subsequent gelatinization of the native starch that occurs during the heating and drying process helps to rapidly attain a viscosity needed to bind the ingredients together. This native starch also helps to pull water away from the other ingredients while being heated and causes a decrease in drying time.

In another embodiment, the present invention relates to a meal replacement product comprising the aqueous based binder composition mixed with dry food ingredients consisting of nuts, seeds, grains and seasoning. The preferred binder concentration is about 5 to 20% of the total ingredient weight. The said ingredients will preferably include seeds and plant components, such as mustard seed, flax seed, chia seed, cactus, seaweed, etc., with natural mucilage coatings and/or food items such as precooked and dehydrated grains including puffed/extruded quinoa, oat, rice, millet, sorghum, amaranth, buckwheat, corn, teff etc., that produce mucilaginous substances/coatings upon heat treatment. The mucilaginous substances and starch component act synergistically, to increase the binding capacity of the aqueous based binder composition. The important role of mucilaginous coating is evidenced by the lack or minimal binding that occurs when the starch binders are added to a blend of non-mucilaginous substance comprising ingredients such as mixed nut pieces.

Gums and mucilage are known to act in synergy with starch through electrostatic interactions, which play an important role in altering pseudoplasticity of starch pastes, causing higher paste viscosities at low shear rates and enhanced binding properties. However, until this invention, these properties have not been applied to cause aggregation and binding of loosely assembled food ingredients to produce savory and/or non-sweet snacks and food products. Those skilled in the art will understand that this binder component of the food product can be derived from a number of other sources comprising combinations of isolated polysaccharides (e.g. gums, mucilages and pectin), mucilaginous plant extracts and products (cactus, aloe vera, kelp, okra, Chinese yam, etc.), solubilized fibers with storage polysaccharides (e.g. starch, fructans and galactomannans), algae and/or microorganisms.

One preferred method for altering the viscosity of binder to a desired level that causes bonding of ingredients in the food product involves heating the aggregated food product to increase viscosity simultaneously during the drying process. The preferred heating temperature of the aggregated or compacted food product is about 170 to 350 degree F. to obtain a bound food product of water activity below 0.6. In an embodiment, additional starch can be optionally added to the dry ingredients, prior to mixing with the binder which helps to pull moisture away from the ingredients. Optional coating and modifications to the texture and flavor of food products can be accomplished by the addition of low sugar syrups, the preferred range of which is DE 25 to DE 35. Shaping of the final food product by cutting or slicing can be carried out prior to heating the aggregated product to cause permanent binding or after the heating and drying process. The shape of the formed product is not easily changed, except by cutting or slicing. The combined use of food ingredients that are crunchy such as nuts, seeds, puffed/extruded grain products and addition of herbs and spices to the binder will result in a savory and crunchy final food product.

The above preferred components and process will typically yield a food product with about 0 to 2 grams of sugar in a 40 gram serving of product. An additional attribute of the food product is the visible food components that serve as visual cues for a healthy snack. In addition to the use of non-sweet binder, the meal replacement products offers distinctly different flavor profiles from majority of those currently exist in the market. The meal replacement food products comprising increased quantity of nuts and seeds facilitates further creation of consumer outlets for these healthy foods. Nuts and seeds are nutrient-dense and are reliable sources of essential nutrients such as essential oils, protein, fiber and complex carbohydrates, vitamins, minerals and phytochemicals. The preferred ingredients of the above food product provide fat compositions with over 75% unsaturated mono and polyunsaturated content, and comprises very low sugar content, low glycemic index, gluten free, and are good sources of fiber and protein. The food product will also provide better options for underserved cohorts such as vegans, lacto and/or ovo-vegetarians, gluten sensitive individuals and those trying to limit their sugar consumption.

The following examples further illustrate various features of the present invention, and are not intended to delineate the scope of the invention or limit the claims. Likewise, this disclosure and description does not exclude modifications and alterations within the true scope and spirit of the invention.

### Example 1

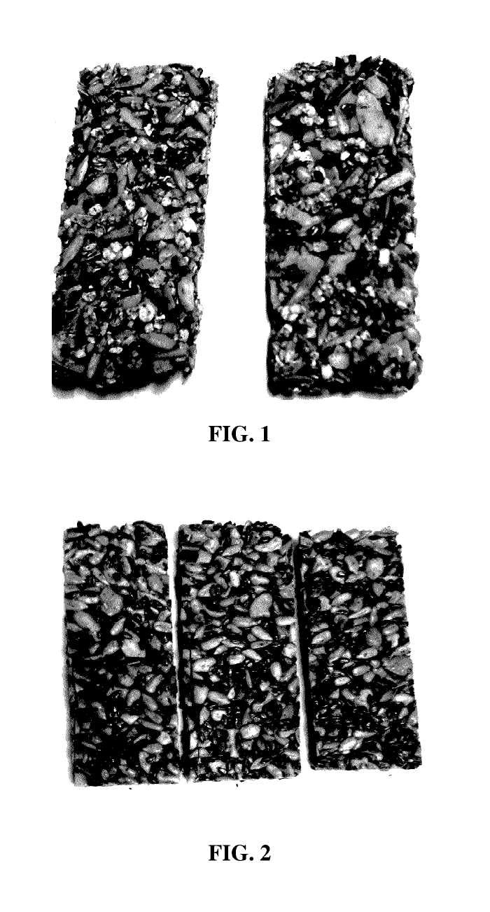

A savory food bar as shown in FIG. 1, prepared using dry ingredients such as almond, flax seed, sunflower seed, whole oat, along with a non-sweet binder comprising tapioca syrup and tapioca starch. Component ingredients of the food bar and nutritional composition are provided in Table 1.

TABLE 1

| | |
|---|---|
| Serving Size (g) | 40 |
| Calories | 190 |
| Calories from Fat | 110 |
| Total Fat (g) | 13 |
| Saturated Fat (g) | 3 |
| Sodium (mg) | 215 |
| Carbohydrate (g) | 16 |
| Dietary Fiber (g) | 5 |
| Sugar (g) | 1 |
| Protein (g) | 7 |

Ingredients: Almond, Flax Seed, Sunflower Seed, Whole Oat, Tapioca Syrup, Tapioca Starch, Sea Salt, Nutmeg, Garlic, Onion, Red Pepper, Black Pepper, Chili Pepper

### Example 2

### A savory food bar as shown in FIG. 2, prepared using dry ingredients

such as cashew nut, flax seed, sunflower seed, along with non-sweet binder comprising tapioca syrup/tapioca starch and seasonings. Component ingredients of the food bar and nutritional composition are provided in Table 2.

TABLE 2

| | |
|---|---|
| Serving Size (g) | 40 |
| Calories | 211 |
| Calories from Fat | 137 |
| Total Fat (g) | 16 |
| Saturated Fat (g) | 2 |
| Sodium (mg) | 218 |
| Carbohydrate (g) | 14 |
| Dietary Fiber (g) | 4 |
| Sugar (g) | 2 |
| Protein (g) | 6 |

Ingredients: Cashew nut, Sunflower Seed, Flax Seed, Tapioca Syrup, Tapioca Starch, Sea Salt, Garlic, Onion, Black Pepper, Cinnamon, Nutmeg, Cayenne Pepper.

### Example 3

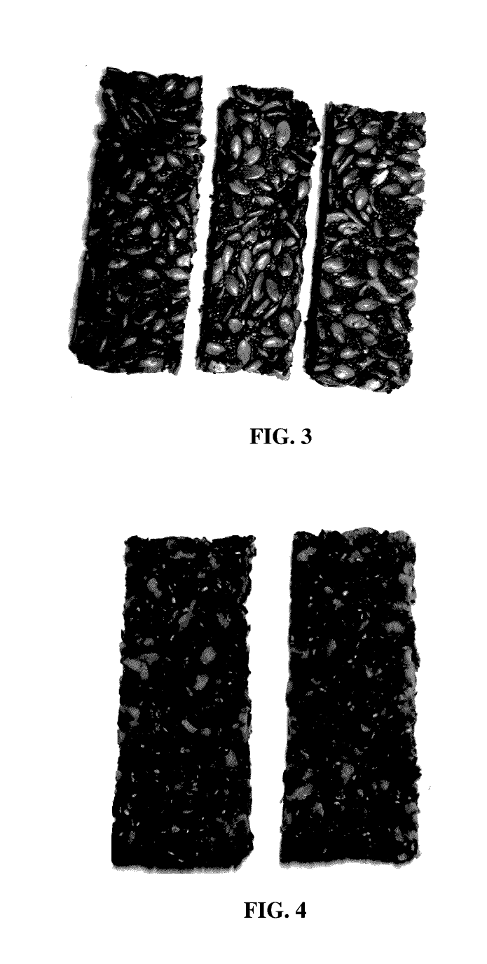

A savory food bar as shown in FIG. 3, prepared using dry ingredients such as pumpkin seed, chia seed, along with non-sweet binder comprising tapioca starch and seasonings. Component ingredients of the food bar and nutritional composition are provided in Table 3.

TABLE 3

| | |
|---|---|
| Serving Size (g) | 40 |
| Calories | 199 |
| Calories from Fat | 133 |
| Total Fat (g) | 16 |
| Saturated Fat (g) | 3 |
| Sodium (mg) | 221 |
| Carbohydrate (g) | 5 |
| Dietary Fiber (g) | 3 |
| Sugar (g) | 0 |
| Protein (g) | 8 |

Ingredients: Pumpkin Seed, Chia Seed, Tapioca Starch, Sea Salt, Garlic, Onion, Ginger, Black Pepper, Cayenne Pepper

### Example 4

A savory food bar as shown in FIG. 4, prepared using dry ingredients such as walnut, flax seed, chia seed, along with non-sweet binder comprising tapioca syrup, potato starch and seasonings. Component ingredients of the food bar and nutritional composition are provided in Table 4.

TABLE 4

| | |
|---|---|
| Serving Size (g) | 40 |
| Calories | 201 |
| Calories from Fat | 145 |
| Total Fat (g) | 16 |
| Saturated Fat (g) | 2 |
| Sodium (mg) | 218 |
| Carbohydrate (g) | 12 |
| Dietary Fiber (g) | 5 |
| Sugar (g) | 1 |
| Protein (g) | 5 |

Ingredients: Walnut, Flax Seed, Chia Seed, Tapioca Syrup, Potato Starch, Sea Salt, Garlic, Onion, Black Pepper, Cinnamon, Nutmeg, Cayenne Pepper

### Example 5

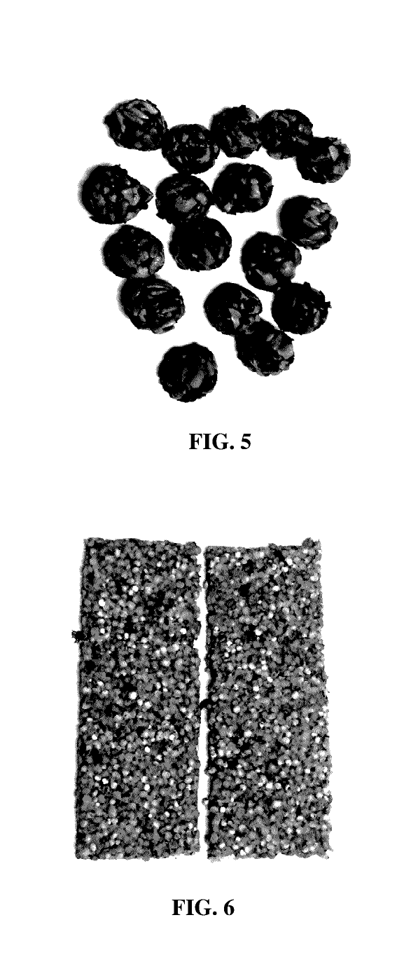

### A savory edible bite size food product as shown in FIG. 5, prepared using

dry ingredients such as peanut, sunflower seed, flax seed, along with non-sweet binder comprising tapioca syrup, tapioca starch and seasonings. Component ingredients of the food bar and nutritional composition are provided in Table 5.

TABLE 5

| | |
|---|---|
| Serving Size (g) | 40 |
| Calories | 211 |
| Calories from Fat | 137 |
| Total Fat (g) | 16 |
| Saturated Fat (g) | 2 |
| Sodium (mg) | 218 |
| Carbohydrate (g) | 14 |
| Dietary Fiber (g) | 4 |
| Sugar (g) | 2 |
| Protein (g) | 6 |

Ingredients: Peanut, Sunflower Seed, Flax Seed, Tapioca Syrup, Tapioca Starch, Sea Salt, Garlic, Onion, Black Pepper, Cinnamon, Nutmeg, Cayenne Pepper

### Example 6

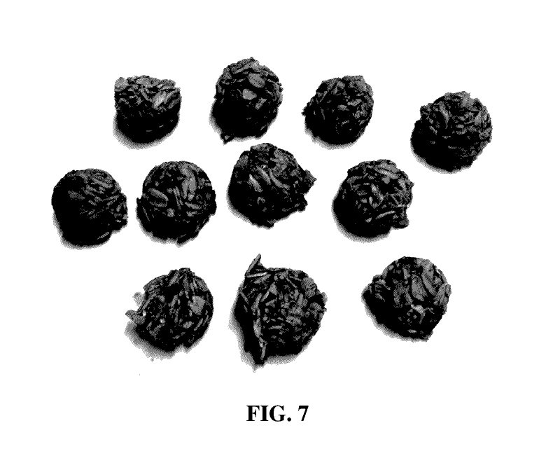

A savory edible food bar as shown in FIG. 6, prepared using Quinoa, along with non-sweet binder comprising tapioca starch and seasonings. Component ingredients of the food bar and nutritional composition are provided in Table 6.

TABLE 6

| | |
|---|---|
| Serving Size (g) | 40 |
| Calories | 132 |
| Calories from Fat | 20 |
| Total Fat (g) | 2 |
| Saturated Fat (g) | 0 |
| Sodium (mg) | 220 |
| Carbohydrate (g) | 27 |
| Dietary Fiber (g) | 2 |
| Sugar (g) | 0 |
| Protein (g) | 5 |

Ingredients: Quinoa, Tapioca Starch, Sea Salt, Onion, Black Pepper, Garlic, Parsley, Tomato Powder, Thyme, Basil

### Example 7

A savory edible bite size food product prepared using toasted oat, vanilla extract, and cinnamon along with non-sweet binder comprising tapioca starch. Component ingredients of the food bar and nutritional composition are provided in Table 7.

TABLE 7

| | |
|---|---|
| Serving Size (g) | 40 |
| Calories | 138 |
| Calories from Fat | 19 |
| Total Fat (g) | 2 |
| Saturated Fat (g) | 0 |
| Sodium (mg) | 220 |
| Carbohydrate (g) | 26 |
| Dietary Fiber (g) | 4 |
| Sugar (g) | 0 |
| Protein (g) | 5 |

Ingredients: Toasted Oat, Tapioca Starch, Sea Salt, Vanilla Extract and Cinnamon

What is claimed is:

1. A non-sweet binder for a food product, the binder composition comprising:
a starch component comprising a combination of pre-gelled starch and native starch and a mucilage, dispersed in an aqueous medium forming an aqueous binder,
wherein the mucilage acts synergistically with the starch component to improve aggregation and binding of a plurality of ingredients of the food product,
wherein the presence of pre-gelled starch increases viscosity of the aqueous binder which allow aggregation of the plurality of ingredients at ambient temperature, without any need to heat the aqueous binder,
wherein the aqueous binder allows shaping of the food product without substantial modification in nutritional value, wherein the aqueous binder contributes to less than 15 calories and less than 3 grams of fat per 40 grams serving of the food product.

2. The non-sweet binder composition of claim 1, wherein the starch component is obtained from at least one plant source.

3. The non-sweet binder composition of claim 2, wherein the starch component is obtained from a group consisting corn, lotus root, taro root, rice, tapioca, arrowroot, potato, and kudzu.

4. The non-sweet binder composition of claim 1, wherein the aqueous medium comprises water.

5. The non-sweet binder composition of claim 1, wherein the aqueous medium optionally comprises a food grade aqueous solution selected from a group consisting fruit juices, vegetable juices or purees, fermentation products, broth, stock solution and its combinations.

6. The non-sweet binder composition of claim 1, wherein the mucilage is obtained from isolated polysaccharides, grains, seeds, plant extracts and plant products.

7. The non-sweet binder composition of claim 1, further optionally comprises health and wellness enablers comprising bio-actives, essential fatty acids, and antioxidants.

8. The non-sweet binder composition of claim 1, further optionally comprises flavorings, oils, sweeteners, emulsifiers, micronutrients, vitamins, minerals, and coloring.

9. The non-sweet binder composition of claim 1, comprises about 85 to 99 percentage by weight of moisture content.

10. The non-sweet binder composition of claim 1 is essentially free of added high calorie sweetener, fats, sugar alcohols, gluten, hydrolyzed polysaccharides, gums and added colloidal materials.

11. The non-sweet binder composition of claim 1, wherein the mucilage is selected from seed and plant components with natural mucilaginous coating and preprocessed grains that produce mucilaginous coating upon heat treatment.

12. (canceled)

13. A meal replacement food product, comprising an aqueous based non-sweet binder composition of claim 1, mixed with dry food components selected from a group consisting of nuts, seeds, grains and seasoning.

14. The food product of claim 13, wherein said nuts are selected from a group consisting of roasted or raw cashews, peanuts, almonds, pecans, hazelnuts, walnuts, pistachios, Brazil nuts and its combinations.

15. The food product of claim 13, wherein said seeds are selected from a group consisting of roasted or raw sunflower seed, flax seed, pumpkin seed, chia seed, sesame seed, squash seed, mustard seed, and its combinations.

16. The food product of claim 13 wherein the said grains are selected from a group consisting of quinoa, oat, rice, millet, sorghum, amaranth, buckwheat, corn, teff and its combinations.

17. The food product of claim 13, comprises a water activity (Aw) ranging between about 0.30 and about 0.60.

18. The food product of claim 13 contains, per 40 g serving, at least about 5 g protein contributed naturally from ingredients without fortification.

19. The food product of claim 13, contains about 0 to 2 grams of sugar per 40 g serving.

20. The food product of claim 13, contains per 40 g serving, at least about 3 g dietary fiber contributed naturally from ingredients without fortification.

21. The food product of claim 13 wherein the fat content is essentially contributed by nuts, seeds and grains, and fat compositions with over 75% unsaturated mono and polyunsaturated content.

22. The food product of claim 13, comprises a shape selected from the group consisting of a bar, a bite size, a square, a sphere and an irregular shape.
